(19) United States
(12) Patent Application Publication
(10) Pub. No.: US 2012/0321955 A1
(43) Pub. Date: Dec. 20, 2012

(54) LITHIUM-ION SECONDARY BATTERY

(75) Inventors: Naoto Yasuda, Kariya-shi (JP); Toru Abe, Kariya-shi (JP); Junichi Niwa, Kariya-shi (JP)

(73) Assignee: KABUSHIKI KAISHA TOYOTA JIDOSHOKKI, Kariya-shi, Aichi (JP)

(21) Appl. No.: 13/581,355

(22) PCT Filed: Apr. 1, 2011
(86) PCT No.: PCT/JP2011/001980

§ 371 Date: Aug. 27, 2012

(30) Foreign Application Priority Data
Apr. 16, 2010 (JP) 2010-095097

(51) Int. Cl. H01M 4/505; H01M 4/485; H01M 4/52; H01M 4/54

(52) U.S. Cl. 429/219; 429/224; 429/220; 429/221; 429/222; 429/223

(57) ABSTRACT

A lithium-ion secondary battery is characterized in that it is equipped with:
a positive electrode comprising a positive-electrode active material that includes a lithium-transition metal composite oxide including at least lithium and manganese and possessing a layered rock-salt structure;
a negative electrode comprising a negative-electrode active material that includes at least one kind of carbon-based materials, silicon-based materials, and tin-based materials; and
a non-aqueous electrolytic solution, wherein:
said lithium-transition metal composite oxide exhibits an irreversible capacity; and
an actual capacity of said negative electrode at the time of first-round charging up to 0 V with respect to metallic lithium is smaller than an actual capacity of said positive electrode at the time of first-round charging up to 4.7 V with respect to metallic lithium.

Even when an employment amount of the active materials is reduced less than those conventional amounts, the resulting battery capacity hardly declines.

### TECHNICAL FIELD

The present invention is one which relates to a lithium-ion secondary battery.

### BACKGROUND ART

Recently, as being accompanied by the developments of portable electronic devices such as cellular phones and notebook-size personal computers, or as being accompanied by electric automobiles being put into practical use, and the like, small-sized, lightweight and high-capacity secondary batteries have been required. At present, as for high-capacity secondary batteries meeting these demands, non-aqueous secondary batteries have been commercialized, non-aqueous secondary batteries in which lithium cobaltate (e.g., LiCoO₂) and the carbon-based materials are used as the positive-electrode material and negative-electrode material, respectively. Since such a non-aqueous secondary battery exhibits a high energy density, and since it is possible to intend to make it downsize and lightweight, its employment as a power source has been attracting attention in a wide variety of fields. However, since LiCoO₂ is produced with use of Co, one of rare metals, as the raw material, it has been expected that its scarcity as the resource would grow worse from now on. In addition, since Co is expensive, and since its price fluctuates greatly, it has been desired to develop positive-electrode materials that are inexpensive as well as whose supply is stable.

Hence, it has been regarded promising to employ lithium-manganese-oxide-based composite oxides whose constituent elements are inexpensive in terms of the prices as well as which include stably-supplied manganese (Mn) in their essential compositions. Among them, a substance, namely, Li₂MnO₃ that comprises tetravalent manganese ions but does not include any trivalent manganese ions making a cause of the manganese elution upon charging and discharging, has been attracting attention.

Incidentally, oxides, such as LiCoO₂ and Li₂MnO₃, exhibit a high electrode potential with respect to metallic lithium, respectively, compared with that of carbon. That is, in a case where these materials are adapted into a positive-electrode material and carbon-based materials are adapted into a negative-electrode material in order to constitute a lithium-ion secondary battery, when the carbon-based materials have degraded due to long-term employments, for instance, lithium becomes likely to precipitate onto the surface of a negative electrode because the negative electrode exhibits a capacity that exceeds the theoretical capacity of carbon. Hence, from the viewpoint of safety, it has been done usually to make a negative-electrode capacity larger than a positive-electrode capacity in order to prevent the precipitation of lithium. And, in this case, a capacity of the resulting secondary battery is determined depending on a capacity of the positive electrode having the smaller capacity (it is called “positive-electrode restriction,” for instance).

On the other hand, in Patent Literature No. 1, there is disclosed a lithium-ion secondary battery with negative-electrode restriction in which the negative electrode's capacity is made smaller than the positive electrode's capacity from the viewpoint of upgrading the shelf life. In this secondary battery, a proportion of lithium, which is released from the positive electrode at the time of charging, is limited by making the negative electrode's capacity smaller than the positive electrode's capacity. As a result, the shelf life upgrades under charged conditions, because the formation of films, which result from the reactions between carbon and electrolytic solutions that are accompanied by the decline in negative-electrode potential, is suppressed, and moreover because the collapse of crystal structure in the positive-electrode active material is suppressed.

### RELATED TECHNICAL LITERATURE

### Patent Literature

Patent Literature No. 1: Published Japanese Translation of PCT Application Gazette No. 2002-151154

### SUMMARY OF THE INVENTION

### Assignment to be Solved by the Invention

In Patent Literature No. 1, there is set forth that it is possible to make a volume of the negative electrode smaller by making the negative-electrode capacity smaller than the positive-electrode capacity. And, it describes that, since carbon-based materials, which have been employed as a negative-electrode active material, have smaller specific gravities than that of lithium-manganese composite oxide, the effect of volume decrease is so great that a volumetric energy density of the resulting battery becomes higher. However, the battery being set forth in Patent Literature No. 1 undergoes the so-called “negative-electrode restriction,” it has such a disadvantage that the initial battery capacity becomes smaller.

The present invention aims at providing a lithium-secondary battery whose battery capacity hardly declines even when an employment amount of active materials is reduced less than those conventional amounts.

### Means, for Solving the Assignment

It has been believed so far that the battery capacity of lithium-ion secondary battery arises from the migration of lithium ions. Therefore, it has been believed that an irreversible capacity occurs because the lithium ions, which have migrated from the positive electrode by means of charging, have come not to migrate while they are kept being absorbed in the negative electrode. However, as a result of an investigation that the present inventors conducted on the charging/discharging characteristic of Li₂MnO₃ serving as a positive-electrode active material, it was understood that positive ions other than lithium ions have been migrated from Li₂MnO₃ to the negative electrode by means of first-round charging. In a case where a lithium-ion secondary battery was assembled with use of a positive electrode, which included a positive-electrode active material comprising Li₂MnO₃, and a negative electrode comprising graphite, this phenomenon was due to the fact that, as a result of subjecting lithium element in the post-first-round-charging negative electrode (i.e., lithium carbide) to an analysis for the average number of valence by means of emission spectroscopic analysis (or ICP) and oxidation-reduction titration, the resulting lithium content was less than its theoretical value being calculated from the resultant charged capacity. To put it differently, it turns out that lithium ions being actually released from the positive electrode, in which Li₂MnO₃ is used as a positive-electrode active material, at the time of first-round charging are less than the apparent charged capacity. Therefore, even when a capacity of the negative electrode is set up so as to be smaller than that of conventional one, the transfer (or losing and gaining) of lithium, which results from charging and discharging, are not affected at all, and hence it was understood that a charged capacity, which is equivalent to that of conventional one, is obtainable. And, the present inventors arrived at completing various inventions being described hereinafter by developing this accomplishment.

Specifically, a lithium-ion secondary battery according to the present invention is characterized in that:

it is a lithium-ion secondary battery being equipped with:
a positive electrode comprising a positive-electrode active material that includes a lithium-transition metal composite oxide including at least lithium and manganese and possessing a layered rock-salt structure;
a negative electrode comprising a negative-electrode active material that includes at least one kind of carbon-based materials, silicon-based materials, and tin-based materials; and
a non-aqueous electrolytic solution;

said lithium-transition metal composite oxide exhibits an irreversible capacity; and

an actual capacity of said negative electrode per unit surface area at the time of first-round charging up to 0 V with respect to metallic lithium is smaller than an actual capacity of said positive electrode per unit surface area at the time of first-round charging up to 4.7V with respect to metallic lithium.

Note that, in a lithium-transition metal composite oxide that is used for the lithium-ion secondary battery according to the present invention, since, of the ions being released by means of first-round charging, not lithium ions, but at least “positive ions other than lithium ion” do not migrate from the negative electrode so that the lithium-transition metal composite oxide comes to exhibit an irreversible capacity, it is believed that a charged capacity, which is equivalent to that of conventional one, is obtainable even when the capacity of the negative electrode is reduced less than those of conventional ones. Although it has been unclear as to the details of “positive ions other than lithium,” the present inventors presume that they are protons. For example, if the lithium-transition metal composite oxide is Li₂MnO₃, since it has been said that the oxygen comes off from Li₂MnO₃ along with the lithium to generate Li₂O, it is presumed that this Li₂O reacts with electrolytic solutions and thereby protons (H⁺) generates. Since such protons have a smaller ionic radius than that of lithium ions, it is believed that they are likely to be absorbed into or adsorbed onto the negative electrode even if the capacity of the negative electrode should have been filled up with absorbed lithium. Moreover, since protons turn into hydrogen-containing gases, such as hydrogen gas and methane gas, at the negative electrode, they are able to make an irreversible capacity even if they are not absorbed in the negative electrode. In the present invention, “positive ions other than lithium ion” of the ions being released from the above-mentioned lithium-transition metal composite will be hereinafter abbreviated to as “protons and the like.”

Here, an “actual capacity” is a practical capacity value when a battery is employed under predetermined employment conditions. That is, an “actual capacity” of the positive electrode at the time of first-round charging is a value into which not only the release of lithium ions from the lithium-transition metal composite oxide but also the release of “protons and the like” are taken into account.

For reference, in Patent Literature No. 1, a lithium-ion secondary battery being subjected to negative-electrode restriction is disclosed. However, the lithium-ion secondary battery according to Patent Literature No. 1 corresponds to later-described Comparative Example No. 2. That is, in Patent Literature No. 1, it is not assumed at all to use a lithium-transition metal composite oxide, which exhibits an irreversible capacity arising from “protons and the like,” as a positive-electrode active material.

### EFFECT OF THE INVENTION

Since the lithium-ion secondary battery according to the present invention shows a capacity that is equivalent to those of conventional ones even when the employment amount of negative-electrode active material is reduced to less than those conventional employment amounts, the charging/discharging efficiency per unit mass of active material enhances. And, since the employment amount of negative-electrode active material becomes less than those of conventional ones, the lithium-ion secondary battery according to the present invention is reduced in the internal capacity, and this therefore leads to making it lighter and smaller.

### MODE FOR CARRYING OUT THE INVENTION

Hereinafter, explanations will be made on some of the best modes for performing the lithium-ion secondary battery according to the present invention. Note that, unless otherwise specified, ranges of numeric values, namely, “from ‘a’ to ‘b’” being set forth in the present description, involve the lower limit, “a,” and the upper limit, “b,” in those ranges. Moreover, the other ranges of numeric values are composable within those ranges of numeric values by arbitrarily combining values that are set forth in the present description.

A lithium-ion secondary battery according to the present invention is mainly equipped with a positive electrode comprising a positive-electrode active material that includes a lithium-transition metal composite oxide including at least lithium and manganese and possessing a layered rock-salt structure, a negative electrode comprising a negative-electrode active material that includes at least one kind of carbon-based materials, silicon-based materials, and tin-based materials, and a non-aqueous electrolytic solution.

As described above, the lithium-ion secondary battery according to the present invention is proved to be effective because it successfully works distinguishably in a case where it employs a positive-electrode active material that includes a lithium-transition metal composite oxide, which exhibits such an irreversible capacity that it does not absorb at least “protons and the like” (namely, of the positive ions that migrate to a counter electrode at the time of first-round charging, positive ions other than lithium ion) at the time of next-round charging. It is possible to define that such a positive-electrode active material includes a lithium-transition metal composite oxide that at least includes lithium and manganese and possesses a layered rock-salt structure, and which exhibits an irreversible capacity.

When expressing the above-mentioned lithium-transition metal composite oxides by a compositional formula, the compositional formula can be Li₂MO₃. A lithium-transition metal composite oxide, in which Li₂MO₃ makes the fundamental composition, possesses a layered rock-salt composition so that it exhibits an irreversible capacity as mentioned above. It is feasible to ascertain this fact using X-ray diffraction, electron-beam diffraction, the above-described ICP analysis, and so forth. In the compositional formula, “M” represents one or more kinds of metallic elements in which tetravalent Mn is essential, and Li may even be substituted by hydrogen in a part thereof.

Note that, in the present description, the phrase, “making the fundamental composition,” shall not be limited to those with a stoichiometric composition, but shall also involve those which occur inevitably in the production to have a non-stoichiometric composition in which Li, Mn or is deficient. In the aforementioned compositional formula, it is also allowable that Li can be substituted by hydrogen (H) in an amount of 60% or less, furthermore 45% or less, by atomic ratio. Moreover, although it is preferable that all of the “M” can be tetravalent manganese (Mn), it is even permissible that less than 50% of the Mn, furthermore less than 80% thereof, can be substituted by another metallic element other than Mn. As for another metallic element, it is preferable to select it from the group consisting of Ni, Al, Co, Fe, Mg, and Ti, from the viewpoint of chargeable/dischargeable capacity in a case where it is adapted into an electrode material.

Moreover, it is also allowable that the positive-electrode active material can further include other compounds, which have been heretofore used conventionally as a positive-electrode active material for lithium-ion secondary battery, independently of the aforementioned lithium-transition metal composite oxide possessing a layered rock-salt structure (hereinbelow being abbreviated to as an “essential lithium-transition metal composite oxide”). To be concrete, LiCoO₂, LiNi_{0.5}Mn_{0.5}O₂, LiNi_{1/3}CO_{1/3}Mn_{1/3}O₂, Li₄Mn₅O₁₂ or LiMn₂O₄, and the like, can be given. Note that these compounds are lithium-transition metal composite oxides in which “protons and the like” do not make the cause of irreversible capacity and whose irreversible capacities are less. It is even permissible to prepare these compounds as a mixed powder in which those are mixed in a powdery state after synthesizing them independently of an essential lithium-transition metal composite oxide. Moreover, depending on their combinations, it is feasible to synthesize these compounds as a solid solution between themselves and an essential lithium-transition metal composite oxide.

On this occasion, it is preferable that the essential lithium-transition metal composite oxide can include an essential lithium-transition metal composite oxide in an amount of 20% by mol or more when the positive-electrode active material is taken as 100% by mol. When being less than 20% by mol, there arises such a possibility that Li might migrate in an amount that surpasses an absorbable lithium amount in the negative electrode in a case where the difference between the actual capacities of the positive electrode and negative electrode is made larger by reducing the employment amount of negative-electrode active material, because an amount of “protons and the like” (namely, of the positive ions that migrate to a counter electrode at the time of first-round charging, “positive ions other than lithium ion”) becomes less. Consequently, as such is not preferable because the dendritic precipitation of metallic lithium becomes likely to occur. Amore preferable content of an essential lithium-transition metal composite oxide can be 30% by mol or more, furthermore 50% by mol or more, when the positive-electrode active material is taken as 100% by mol.

It is preferable that the negative-electrode active material can include at least one kind of the following: carbon-based materials including carbon (C), such as natural graphite, artificial graphite, organic-compound calcined bodies like phenol resins, and carbonaceous powdery bodies like cokes; silicon-based materials including silicon (Si), such as silicon simple substance, silicon oxides and silicon compounds: and tin-based materials including tin (Sn), such as tin, tin oxides and tin compounds. These materials are suitable for a negative-electrode material for the lithium-ion secondary battery according to the present invention, because their electrode potentials are low with respect to that of metallic lithium.

In the lithium-ion secondary battery according to the present invention, an actual capacity of the negative electrode is smaller than an actual capacity of the positive electrode. The definition of the “actual capacity” has been as described above. Here, both the actual capacities of the positive electrode and negative electrode to be compared with each other are defined as a practical capacity value in an electrochemical cell in which metallic lithium is used for the counter electrode, respectively. The actual capacity of the positive electrode is defined as a practical capacity value per unit surface area at the time of first-round charging up to 4.7 V with respect to metallic lithium. The actual capacity of the negative electrode is defined as a practical capacity value per unit surface area at the time of first-round charging up to 0 V with respect to metallic lithium. Note that an actual capacity per unit surface area is calculated using an area of the positive electrode or negative electrode that faces to the counter electrode. It is desirable that other conditions can be set up so that the positive electrode and the negative electrode are put under identical conditions to each other. As for the other conditions, the following can be given: the charging/discharging conditions other than voltages (e.g., the current density, and the like); the constitutions of the electrochemical cell (e.g., the separator, the types and concentrations of the electrolyte, and so forth); the contents of the positive-electrode active material and negative-electrode active material; the measurement temperature, and so on.

The actual capacities of the positive electrode and negative electrode being obtainable by means of the above-mentioned method are their inherent values that are determined mainly by means of the types of active materials and the contents of active materials. Therefore, it is advisable to select the actual capacities of the negative electrode and positive electrode so that the former becomes smaller than the latter by adjusting the combinations of the positive-electrode active material and negative-electrode active material, the content of an essential lithium-transition metal composite oxide being included in the positive-electrode active material, and the like.

Incidentally, it has been said that, in an essential lithium-transition metal composite oxide, approximately two-thirds (or 66%) of the positive ions (i.e., the lithium ions and protons, or the like), which have been released by means of first-round charging, are the lithium ions that contribute to charging and discharging. In addition, the lithium is consumed because of the fact that reactions between the negative-electrode active material and the electrolytic solution proceed so that films are formed on the negative electrode's surface. Consequently, the lithium ions that can actually contribute to charging and discharging become less than 66%. Since the actual capacity of the negative electrode can be available in such a magnitude that matches up to the lithium ions that actually contribute to charging and discharging, it is allowable that the actual capacity of the negative electrode can be 62% or more of the actual capacity of the positive electrode, or 64% or more thereof, furthermore 67% or more thereof, when the positive-electrode active material is one which comprises an essential lithium-transition metal element alone (namely, the content is 100% by mol). Moreover, in a case where an essential lithium-transition metal composite oxide is included in an amount of 60% by mol or more when the positive-electrode active material is taken as 100% by mol, it is permissible that the actual capacity of the negative electrode can be 70% or more of the actual capacity of the positive electrode, or 73% or more thereof, furthermore 77% or more thereof. Even in any of the cases, although the smaller the actual capacity of the negative electrode is the more preferable it is because it is possible to intend making the resulting lithium-ion secondary battery smaller and more lightweight by reducing the actual capacity of the negative electrode, it is not desirable to make the actual capacity of the negative electrode too small with respect to the actual capacity of the positive electrode because lithium becomes likely to precipitate onto the negative electrode's surface. When defining an upper limit of the actual capacity of the negative electrode with respect to the actual capacity of the positive electrode, the actual capacity of the negative electrode can be less than 100% of the actual capacity of the positive electrode, or 95% or less thereof, furthermore 90% or less thereof.

Note that, even in a case where the content of an essential lithium-transition metal composite oxide is less than 100% by mol, it is feasible to calculate a lithium amount contributing to charging and discharging, and a required actual capacity of the negative electrode by measuring a charging/discharging efficiency during a first cycle, charging/discharging efficiency which results from the essential lithium-transition metal composite oxide alone, and another charging/discharging efficiency during a first cycle, another charging/discharging efficiency which results from another compound only being included in the positive-electrode active material, and then prorating the resulting two charging/discharging efficiencies in compliance with a molar ratio of the other compound being included in the positive-electrode active material.

It is preferable that the positive electrode and negative electrode can mainly comprise the above-mentioned active material, and a binding agent that binds this active material together, respectively. It is al so allowable that they can further include a conductive additive. There are not any limitations especially on the binding agent and conductive additive either, and so they can be those which are employable in common lithium-ion secondary batteries. The conductive additive is one for securing the electric conductivity of electrode, and it is possible to use for the conductive additive one kind of carbon-substance powders, such as carbon blacks, acetylene blacks and graphite, for instance; or those in which two or more kinds of them have been mixed with each other. The binding agent is one which accomplishes a role of fastening and holding up the active material and the conductive additive together, and it is possible to use for the binding agent the following: fluorine-containing resins, such as polyvinyl idene fluoride, polytetrafluoroethylene and fluororubbers; or thermoplastic resins, such as polypropylene and polyethylene, and the like, for instance.

It is common that the positive electrode and negative electrode are made by adhering an active-material layer, which is made by binding at least a positive-electrode active material or negative-electrode active material together with a binding agent, onto a current collector. Consequently, the positive electrode and negative electrode can be formed as follows: a composition for forming electrode mixture-material layer, which includes an active material and a binding agent as well as a conductive additive, if needed, is prepared; the resulting composition is applied onto the surface of a current collector after an appropriate solvent has been further added to the resultant composition to make it pasty, and is then dried thereon; and the composition is compressed in order to enhance the resulting electrode density, if needed.

For the current collector, it is possible to use meshes being made of metal, or metallic foils. As for a current collector, porous or nonporous electrically conductive substrates can be given, porous or nonporous electrically conductive substrates which comprise: metallic materials, such as stainless steels, titanium, nickel, aluminum and copper; or electrically conductive resins. As for a porous electrically conductive substrate, the following can be given: meshed bodies, netted bodies, punched sheets, lathed bodies, porous bodies, foamed bodies, formed bodies of fibrous assemblies like nonwoven fabrics, and the like, for instance. As for a nonporous electrically conductive substrate, the following can be given: foils, sheets, films, and so forth, for instance. As for an applying method of the composition for forming electrode mixture-material layer, it is allowable to use a method, such as doctor blade or bar coater, which has been heretofore known publicly.

As for a solvent for viscosity adjustment, the following are employable: N-methyl-2-pyrrolidone (or NMP), methanol, methyl isobutyl ketone (or MIBK), and the like.

As for an electrolyte, it is possible to use organic-solvent-based electrolytic solutions, in which an electrolyte has been dissolved in an organic solvent, or polymer electrolytes, in which an electrolytic solution has been retained in a polymer, and the like. Although the organic solvent, which is included in that electrolytic solution or polymer electrolyte, is not at all one which is limited especially, it is preferable that it can include a chain ester (or a linear ester) from the perspective of load characteristic. As for such a chain ester, the following organic solvents can be given: chain-like carbonates, which are represented by dimethyl carbonate, diethyl carbonate and ethyl methyl carbonate; ethyl acetate; and methyl propionate, for instance. It is also allowable to use one of these chain or linear esters independently, or to mix two or more kinds of them to use. In particular, in order for the improvement in low-temperature characteristic, it is preferable that one of the aforementioned chain esters can account for 50% by volume or more in the entire organic solvent; especially, it is preferable that the one of the chain esters can account for 65% by volume or more in the entire organic solvent.

However, as for an organic solvent, rather than constituting it of one of the aforementioned chain esters alone, it is preferable to mix an ester whose permittivity is high (e.g., whose permittivity is 30 or more) with one of the aforementioned chain esters to use in order to intend the upgrade in discharged capacity. As for a specific example of such an ester, the following can be given: cyclic carbonates, which are represented by ethylene carbonate, propylene carbonate, butylene carbonate and vinylene carbonate; γ-butyrolactone; or ethylene glycol sulfite, and the like, for instance. In particular, cyclically-structured esters, such as ethylene carbonate and propylene carbonate, are preferable. It is preferable that such an ester whose permittivity is high can be included in an amount of 10% by volume or more in the entire organic solvent, especially 20% by volume or more therein, from the perspective of discharged capacity. Moreover, from the perspective of load characteristic, 40% by volume or less is more preferable, and 30% by volume or less is much more preferable.

As for an electrolyte to be dissolved in the organic solvent, one of the following can be used independently, or two or more kinds of them can be mixed to use: LiClO₄, LiPF₆, LiBF₄, LiAsF₆, LiSbF₆, LiCF₃SO₃, LiC₄F₉SO₃, LiCF₃CO₂, Li₂C₂F₄ (SO₃)₂, LiN(CF₃SO₂)₂, LiC(CF₃SO₂)₃, or LiCₙF₂ₙ₊₁SO₃ (where “n”≧2), and the like, for instance. Among them, LiPF₆ or LiC₄F₉SO₃, and so forth, from which favorable charging/discharging characteristics are obtainable, can be used preferably.

Although a concentration of the electrolyte in the electrolytic solution is not at all one which is limited especially, it can preferably be from 0.3 to 1.7 mol/dm³, especially from 0.4 to 1.5 mol/dm³ approximately.

Moreover, in order to upgrade the safety or storage characteristic of battery, it is also allowable to make a non-aqueous electrolytic solution contain an aromatic compound. As for an aromatic compound, benzenes having an alkyl group, such as cyclohexylbenzene and t-butylbenzne, biphenyls, or fluorobenzenes can be used preferably.

It is advisable that the lithium-ion secondary battery according to the present invention can be further equipped with a separator to be held or set between the positive electrode and the negative electrode in the same manner as common lithium-ion secondary batteries.

As for a separator, it is allowable to use those which have sufficient strength, and besides which can retain electrolytic solutions in a large amount. From such a viewpoint, it is possible to use the following, which have a thickness of from 5 to 50 μm, preferably: micro-porous films which are made of polypropylene, polyethylene or polyolefin, such as copolymers of propylene and ethylene; or nonwoven fabrics, and the like.

A configuration of the lithium-ion secondary battery according to the present invention can be made into various sorts of those such as cylindrical types, laminated types and coin types. Even in a case where any one of the configurations is adopted, the separators are interposed between the positive electrodes and the negative electrodes to make electrode assemblies. And, these electrode assemblies are sealed hermetically in a battery case after connecting intervals from the resulting positive-electrode current-collector assemblies and negative-electrode current-collector assemblies up to the positive-electrode terminals and negative-electrode terminals, which lead to the outside, with leads for collecting electricity, and the like, and then impregnating these electrode assemblies with the aforementioned electrolytic solution, and thereby a lithium-ion secondary battery completes.

In case where lithium-ion secondary batteries are made use of, the positive-electrode active material is activated by carrying out charging in the first place. However, in a case where one of the above-mentioned composite oxides (i.e., one of the essential lithium-transition metal composite oxides) is used as a positive-electrode active material, lithium ions are released at the time of first-round charging, and simultaneously therewith oxygen generates. Consequently, it is desirable to carry out charging before sealing the battery case hermetically.

The lithium-ion secondary battery according to the present invention can be utilized suitably in the field of automobile in addition to the field of communication device or information-related device such as cellular phones and personal computers. For example, when vehicles have this lithium-ion secondary battery on-board, it is possible to employ the lithium-ion secondary battery as an electric power source for electric automobile.

So far, some of the embodiment modes of the lithium-ion secondary battery according to the present invention have been explained. However, the present invention is not one which is limited to the aforementioned embodiment modes. It is possible to execute the present invention in various modes, to which changes or modifications that one of ordinary skill in the art can carry out are made, within a range not departing from the gist.

### EXAMPLES

Hereinafter, the present invention will be explained in detail while giving specific examples of the lithium-ion secondary battery according to the present invention.

### Making of Negative Electrode

A negative electrode, which included graphite as a negative-electrode active material, was made.

Graphite, an acetylene black (i.e., a conductive additive), and polyvinylidene fluoride (i.e., a binding agent) were mixed so as to make a ratio, 92:3:5 by mass ratio. They were dispersed in N-methyl-2-pyrolidone (or NMP), thereby obtaining a slurry. This slurry was coated onto a copper foil with 10 μm in thickness, namely, a current collector, and was then vacuum-dried at 120° C. for 12 hours or more. After drying the slurry, the coated copper foil was pressed to punch it out to a size of φ16 mm in diameter, thereby adapting it into a negative electrode. Note that the coated amount of the slurry was 9 mg/cm² by the conversion into negative-electrode active material.

For the obtained electrode, an electrode capacity (or an actual capacity) was measured in a voltage range of from 0 V to 1.2 V after making an electrochemical cell in which metallic lithium made the counter electrode. Note that the electrochemical cell was made as follows: a non-aqueous electrolytic solution, in which LiPF₆ was dissolved in a concentration of 1.0 mol/L into a mixed solvent in which ethylene carbonate and ethyl methyl carbonate were mixed in a volumetric ratio of 1:2, was used as the electrolytic solution; and a microporous polyethylene film having a thickness of 20 μm, which served as the separator, was put in place between the two electrodes. Using this electrochemical cell, a charging/discharging test was carried out at a constant temperature of 30° C. under a condition of 0.2C. As a result, a first-round charged capacity of this electrode was 335 mAh/g per unit mass of the negative-electrode active material (i.e., 3.0 mAh/cm² per unit surface area of the negative electrode).

### Making of Positive Electrode

A positive electrode, which included Li₂MnO₃ as a positive-electrode active material, was made.

Li₂MnO₃ with 200 nm in average primary particle diameter was made ready. The Li₂MnO₃, an acetylene black, and polyvinylidene fluoride were mixed so as to make a ratio, 80:10:10 by mass ratio. They were dispersed in NMP, thereby obtaining a slurry. This slurry was coated onto an aluminum foil with 15 μm in thickness, namely, a current collector, and was then vacuum-dried at 120° C. for 12 hours or more. After drying the slurry, the coated aluminum foil was pressed to punch it out to a size of φ16 mm in diameter, thereby adapting it into a positive electrode. Note that the coated weight of the resulting electrode was set at either 5 mg/cm² or 10 mg/cm² by the conversion into negative-electrode active material, thereby making two types of positive electrodes being labeled #01 and #02, respectively.

Moreover, positive electrodes #03 through #06 were made in the same procedure as aforementioned, positive electrodes #03 through #06 which included, instead of the Li₂MnO₃, 0.6Li₂MnO₃-0.2LiNi_{0.5}Mn_{0.5}O₂.0.2LiNi_{1/3}Mn_{1/3}CO_{1/3}O₂, 0.6Li₂MnO₃-0.4Li₄Mn₅O₁₂, 0.3Li₂MnO₃-0.7LiNi_{0.5}Mn_{0.5}O₂ or LiNi_{0.5}Mn_{0.5}O₂ (any of these had 200 nm in average primary particle diameter) as a positive-electrode active material.

That is, #01 and #02 were adapted into positive electrodes that included 100%-by-mol Li₂MnO₃, which releases ions other than lithium at the time of charging, as the positive-electrode active material; #03 and #04 were adapted into positive electrodes that included 60%-by-mol Li₂MnO₃; #05 was adapted into a positive electrode that included 30%-by-mol Li₂MnO₃; and #06 was adapted into a positive electrode that did not include any Li₂MnO₃.

For each of the electrodes, an electrode capacity was measured in a voltage range of from 4.7 V to 2.0 V after making an electrochemical cell in which metallic lithium made the counter electrode. Note that the electrochemical cell was made as follows: anon-aqueous electrolytic solution, in which LiPF₆ was dissolved in a concentration of 1.0 mol/L into a mixed solvent in which ethylene carbonate and ethyl methyl carbonate were mixed in a volumetric ratio of 1:2, was used as the electrolytic solution; and a microporous polyethylene film having a thickness of 20 μm, which served as the separator, was put in place between the two electrodes. Using this electrochemical cell, a constant-current and constant-voltage charging/constant-current discharging charge/discharge test was carried out at a constant temperature of 30° C. under a condition of 0.2C. The positive electrodes' first-round charged capacities that were obtained by means of the charge/discharge test, and their subsequent discharged capacities (namely, the charged/discharged capacities during a first cycle) are given in Table 1 as the values per unit mass of the positive-electrode active materials, and as the values per unit area of the positive electrodes, respectively.

TABLE 1

| | Positive-electrode Active Material | | | | | | | |
|---|---|---|---|---|---|---|---|---|
| | | | Active- | Positive- | | Positive- | | |
| | | | material | electrode | | electrode | | |
| | | Li₂MnO₃ | Amount | Charged | | Discharged | | Charging/ |
| | | Content | (or Coated | Capacity | | Capacity | | Discharging |
| | | (% by | Amount) | | (mAh/ | | (mAh/ | Efficiency |
| | Composition | mol) | (mg/cm²) | (mAh/g) | cm²) | (mAh/g) | cm²) | (%) |
| #01 | Li₂MnO₃ | 100 | 5 | 420 | 2.10 | 260 | 1.30 | 61.9 |
| #02 | Li₂MnO₃ | 100 | 10 | 420 | 4.20 | 260 | 2.60 | 61.9 |
| #03 | 0.6Li₂MnO₃—0.2LiNi_{0.5}Mn_{0.5}O₂—0.2LiNi_{1/3}Mn_{1/3}Co_{1/3}O₂ | 60 | 10 | 380 | 3.80 | 255 | 2.55 | 67.1 |
| #04 | 0.6Li₂MnO₃—0.4Li₄Mn₅O₁₂ | 60 | 15 | 217 | 3.25 | 140 | 2.10 | 64.6 |
| #05 | 0.3Li₂MnO₃—0.7LiNi_{0.5}Mn_{0.5}O₂ | 30 | 12 | 300 | 3.60 | 210 | 2.52 | 70.0 |
| #06 | LiNi_{0.5}Mn_{0.5}O₂ | 0 | 15 | — | 3.20 | — | 3.05 | 95.3 |

The negative electrode, in which graphite was used as the negative-electrode active material, had the active material in an amount of 9 mg/cm², and exhibited a capacity of 335 mAh/g (or 3.0 mAh/cm²).

Hereinbelow, the charged capacities of the negative electrode and positive electrode during a first cycle will be set forth as the “actual capacities” of the positive electrode and negative electrode.

From Table 1, it was understood that, in the positive-electrode active material directed to #01 and #02, the resulting charging/discharging efficiency indicated that about 38% of the charged capacity was an irreversible capacity. The positive-electrode active material directed to #01 and #02 had Li₂MnO₃ in an amount of 100% by mol. However, in the positive-electrode active materials directed to #03 through #05 whose content proportion of Li₂MnO₃ was lesser, the lesser the content proportion of Li₂MnO₃ was the more the resultant irreversible capacity decreased.

### Making of Lithium-ion Secondary Batteries

### Example No. 1

The above-mentioned negative electrode, whose actual capacity was 3.0 mAh/cm², and Positive Electrode #02, whose actual capacity was 4.2 mAh/cm², were combined to make a coin-shaped lithium-ion secondary battery. A non-aqueous electrolytic solution, which was made by dissolving LiPF₆ in an amount of 1.0 mol/L into a mixed solvent in which ethylene carbonate and ethyl methyl carbonate had been mixed in a volumetric ratio of 1:2, was used as the electrolytic solution, and a microporous polyethylene film with 20 μm in thickness was put in place between the two electrodes as the separator.

### Example No. 2

The above-mentioned negative electrode, whose actual capacity was 3.0 mAh/cm², and Positive Electrode #03, whose actual capacity was 3.8 mAh/cm², were combined to make a lithium-ion secondary battery.

### Example No. 3

The above-mentioned negative electrode, whose actual capacity was 3.0 mAh/cm², and Positive Electrode #04, whose actual capacity was 3.25 mAh/cm², were combined to make a lithium-ion secondary battery.

### Example No. 4

The above-mentioned negative electrode, whose actual capacity was 3.0 mAh/cm², and Positive Electrode #05, whose actual capacity was 3.6 mAh/cm², were combined to make a lithium-ion secondary battery.

### Comparative Example No. 1

The above-mentioned negative electrode, whose actual capacity was 3.0 mAh/cm², and Positive Electrode #01, whose actual capacity was 2.1 mAh/cm², were combined to make a lithium-ion secondary battery.

### Comparative Example No. 2

The above-mentioned negative electrode, whose actual capacity was 3.0 mAh/cm², and Positive Electrode #06, which did not include any Li₂MnO₃ and whose actual capacity was 3.2 mAh/cm², were combined to make a lithium-ion secondary battery.

### Evaluation

### Charging/Discharging Test on Lithium-ion Secondary Batteries

Using each of the above-mentioned lithium-ion secondary batteries, a constant-current and constant-voltage charging/constant-current discharging charge/discharge test was carried out in a range of from 4.6 V to 1.9 V at a rate of 0.2C under a constant-temperature condition of 30V. First-round charged capacities and subsequent discharged capacities (namely, the charged/discharged capacities during a first cycle), which were obtained by means of the charge/discharge test, are given in Table 2 as the values per unit mass of the positive-electrode active materials, and as the values per unit area of the positive electrodes, respectively.

Moreover, with respect to the lithium-ion secondary battery according to Example No. 1, another constant-current and constant-voltage charging/constant-current discharging charge/discharge test was further carried out in a range of from 4.5 V to 1.9 V, or in a range of from 4.0 V to 1.9 V, at a rate of 0.2C under a constant-temperature condition of 30° C. The resulting charged capacities and discharged capacities during a first cycle are given in Table 2.

TABLE 2

| | | | | | Battery | | |
|---|---|---|---|---|---|---|---|
| | | | Battery Charged | | Discharged | | |
| | Positive | Voltage | Capacity | | Capacity | | Charging/Discharging |
| | Electrode | (V) | (mAh/g) | (mAh/cm²) | (mAh/g) | (mAh/cm²) | Efficiency (%) |
| Ex. | #02 | 4.6-1.9 | 440 | 4.40 | 230 | 2.30 | 52.3 |
| No. 1 | | 4.5-1.9 | — | 2.30 | — | 1.49 | 64.8 |
| | | 4.0-1.9 | — | 0.065 | — | 0.04 | 61.5 |
| Ex. | #03 | 4.6-1.9 | 375 | 3.75 | 240 | 2.40 | 64.0 |
| No. 2 | | | | | | | |
| Ex. | #04 | 4.6-1.9 | 220 | 3.30 | 130 | 1.95 | 59.1 |
| No. 3 | | | | | | | |
| Ex. | #05 | 4.6-1.9 | 305 | 3.66 | 200 | 2.40 | 65.6 |
| No. 4 | | | | | | | |
| Comp. | #01 | 4.6-1.9 | 440 | 2.20 | 230 | 1.15 | 52.3 |
| Ex. | | | | | | | |
| No. 1 | | | | | | | |
| Comp. | #06 | 4.6-1.9 | 200 | 3.00 | 190 | 2.85 | 95.0 |
| Ex. | | | | | | | |
| No. 2 | | | | | | | |

The negative electrode had an active material in an amount of 9 mg/cm², and exhibited a capacity of 335 mAh/g (or 3.0 mAh/cm²).

In the lithium-ion secondary battery according to Example No. 1, the negative electrode, which possessed an actual capacity of 3.0 mAh/cm², and Positive Electrode #2, which possessed an actual capacity of 4.2 mAh/cm², were combined to use. That is, this secondary battery was constituted so that the actual capacity of the negative electrode became smaller than the actual capacity of the positive electrode. On the other hand, although the lithium-ion secondary battery according to Comparative Example No. 1 used the same negative electrode as that of Example No. 1, it was constituted so that the actual capacity of the positive electrode became smaller than the actual capacity of the negative electrode. However, no difference occurred between the charged and discharged capacities per unit mass of the positive-electrode active materials in these secondary batteries. That is, it was possible to ascertain that, even when the actual capacity of the negative electrode is reduced, the lithium-ion secondary battery according to Example No. 1 demonstrated performance that was equivalent to that of a conventional lithium-ion secondary battery like Comparative Example No. 1.

Moreover, in the lithium-ion secondary battery according to Example No. 1, Li₂MnO₃ was employed as the positive-electrode active material. On the other hand, LiNi_{0.5}Mn_{0.5}O₂ was employed as the positive-electrode active material in the lithium-ion secondary battery according to Comparative Example No. 2. Although any of the secondary batteries were constituted so that the actual capacity of the negative electrode became smaller than the actual capacity of the positive electrode, the secondary battery according to Example No. 1 showed a charged capacity that approximated the actual capacity of the positive electrode, whereas the secondary battery according to Comparative Example No. 2 showed a charged capacity that approximated the actual capacity of the negative electrode. In other words, the charged capacities of the lithium-ion secondary batteries underwent the “positive-electrode restriction” and “negative-electrode restriction” in Example No. 1 and Comparative Example No. 1, respectively. That is, when the positive-electrode active material is Li₂MnO₃, the resulting lithium-ion secondary batteries are greatly distinct from conventional lithium-ion secondary batteries in that it is feasible to charge all of the actual capacity of the positive electrode even if the actual capacity of the negative electrode is made smaller than the actual capacity of the positive electrode.

Moreover, also in the lithium-ion secondary batteries according to Example Nos. 2 through 4, the charged capacities did not decline greatly even when the batteries were constituted in the same manner as the lithium-ion secondary battery according to Example No. 1 so that they had the positive electrode whose actual capacity was larger than the actual capacity of the negative electrode. Moreover, as to the discharged capacities as well, it was believed that, taking an amount of Li, which was to be consumed in films that were formed on the surface of the negative electrodes, into consideration, there was not any great decline in the capacities.

In short, although the actual capacity of the negative electrode was smaller than the actual capacity of the positive electrode, the lithium-ion secondary batteries according to Example No. 1 through 4 did not differ greatly from the lithium-ion secondary battery according to Comparative Example No. 1 in terms of the charging/discharging efficiency. This indicates that, upon first-round charging, lithium ions migrated from the positive-electrode active materials including Li₂MnO₃ to the counter electrode in such an amount that was less than or did not come up with the actual capacities of the positive electrodes. It is believed that, although the actual capacity of the negative electrode was smaller than the actual capacities of the positive electrodes, the values of the charged capacities were larger because “protons and the like” occurred in the process of charging and then they migrated along with lithium to the negative electrode.

In the lithium-ion secondary battery according to Example No. 1, there was not any great change in the charging/discharging efficiency even when the upper limit of the charging/discharging voltage was changed. In other words, it was understood that the lithium-ion secondary battery according to Example No. 1 could not release the charged capacities completely even in any of the voltage ranges. From this result, it was understood that the charged capacities, which surpassed the actual capacity of the negative electrode, did not at all arise from the decomposition of electrolytic solutions which might possibly be likely to take place in conventional lithium-ion secondary batteries by means of excessive charging, but arise from the fact that positive ions other than Li ions, such as protons, migrated along with lithium ions in the process of charging as set forth above.

1. A lithium-ion secondary battery being characterized in that:
it is a lithium-ion secondary battery being equipped with:
a positive electrode comprising a positive-electrode active material that includes a lithium-transition metal composite oxide including at least lithium and manganese and possessing a layered rock-salt structure;
a negative electrode comprising a negative-electrode active material that includes at least one kind of carbon-based materials, silicon-based materials, and tin-based materials; and
a non-aqueous electrolytic solution;
said lithium-transition metal composite oxide exhibits an irreversible capacity; and
an actual capacity of said negative electrode per unit surface area at the time of first-round charging up to 0 V with respect to metallic lithium is smaller than an actual capacity of said positive electrode per unit surface area at the time of first-round charging up to 4.7V with respect to metallic lithium.

2. The lithium-ion secondary battery as set forth in claim 1, wherein said lithium-transition metal composite oxide exhibits such an irreversible capacity that it does not absorb at least positive ions, which are some of positive ions that are released at the time of first-round charging but which are other than lithium ions, at the time of next-round charging.

3. The lithium-ion secondary battery as set forth in claim 1, wherein said lithium-transition metal composite oxide is expressed by a compositional formula: Li₂MO₃ (where “M” is one or more kinds of metallic elements in which Mn is essential; and Li may even be substituted by hydrogen in a part thereof).

4. The lithium-ion secondary battery as set forth in claim 3, wherein said lithium-transition metal composite oxide is Li₂MnO₃.

5. The lithium-ion secondary battery as set forth in claim 1, wherein said positive-electrode active material includes said lithium-transition metal composite oxide in an amount of 20% by mol or more when said positive-electrode active material is taken as 100% by mol.

6. The lithium-ion secondary battery as set forth in claim 1, wherein said negative-electrode active material is a carbon-based material.

7. A vehicle being characterized in that it has the lithium-ion secondary battery as set forth in claim 1 on-board.
